(19) United States
(12) Patent Application Publication
(10) Pub. No.: US 2015/0277024 A1
(43) Pub. Date: Oct. 1, 2015

(54) DISPLAY DEVICE

(71) Applicant: E Ink Holdings Inc., Hsinchu (TW)

(72) Inventors: Chin-Ju Hsu, Hsinchu (TW); Yu-Nan Pao, Hsinchu (TW); Chia-Chuang Hu, Hsinchu (TW); I-Jeng Chen, Hsinchu (TW)

(21) Appl. No.: 14/583,198

(22) Filed: Dec. 26, 2014

(30) Foreign Application Priority Data
Mar. 31, 2014 (TW) 103111945

(51) Int. Cl. F21V 8/00

(52) U.S. Cl. CPC G02B 6/0045; G02B 6/0081; G02B 6/0073; G02B 6/0055; G02B 6/0036

(57) ABSTRACT

A display device includes a display panel, a light guide plate (LGP), a plurality of rod-shaped light guide structures, and a light source. The display panel has a display surface. The LGP is disposed above the display surface of the display panel and has an upper surface and a lower surface opposite to each other and a light incident surface connecting the upper surface and the lower surface. The rod-shaped light guide structures are disposed on the lower surface of the LGP and expose a portion of the lower surface. Each of the rod-shaped light guide structures protrudes outside or is embedded into the lower surface. The light source is disposed beside the light incident surface.

### CROSS-REFERENCE TO RELATED APPLICATION

This application claims the priority benefit of Taiwan application serial no. 103111945, filed on Mar. 31, 2014. The entirety of the above-mentioned patent application is hereby incorporated by reference herein and made a part of this specification.

### BACKGROUND OF THE INVENTION

1. Field of the Invention

The invention generally relates to a display device, and more particularly, to a display device having a front-light module.

2. Description of Related Art

With the advance in information industry, electronic products with multiple functions (e.g., a display function, a touch-control function, a three-dimensional display function, and so on) have gained popularity due to the convenient use of the electronic products. Currently, these electronic products are characterized by multi-functionality mostly through add-on modules or equipment. For instance, when an electronic device is required to perform the display function and the touch-control function at the same time, the touch panel and the display panel may be adhered to each other by sealant, so as to construct the required electronic device. Certainly, in order to improve the display quality, a front-light module may be additionally adhered or assembled to the front of the display panel (e.g., an electrophoretic display panel) capable of performing the display function, and thereby the required electronic device is obtained.

To be specific, the conventional front-light module is constituted by a light source and a light guide plate (LGP). A lower surface of the LPG nearby the display panel has a plurality of surface microstructures thereon, and a cross-sectional shape of the surface microstructures is arc-shaped, such as a semicircle and so forth, and may be considered as lens structures. When the light is incident to the surface microstructures, sidewalls of the surface microstructures, due to having curves (with a radius of curvature), are apt to produce a secondary reflection and be incident into the an upper surface of the LPG that is relatively away from the display panel. Now, the incident light that incidents to the upper surface of the LPG, due to having a relative small incident angle, is apt to produce a refraction phenomenon and be emitted to the external environment, and thereby is not reflected back into the display panel. As a result, a display contrast performance of the electronic device is reduced.

### SUMMARY OF THE INVENTION

The invention is directed to a display device with favorable display contrast performance.

The display device of the invention includes a display panel, a light guide plate, a plurality of rod-shaped light guide structures, and a light source. The display panel has a display surface. The light guide plate is disposed above the display surface of the display panel and has an upper surface and a lower surface opposite to each other and a light incident surface connecting the upper surface and the lower surface. The rod-shaped light guide structures are disposed on the lower surface of the light guide plate and exposed a portion of the lower surface. Each of the rod-shaped light guide structures protrudes outside or is embedded into the lower surface. The light source is disposed beside the light incident surface of the light guide plate.

In an embodiment of the invention, a distribution density of the rod-shaped light guide structures increases as a distance thereof from the light incident surface progressively increases.

In an embodiment of the invention, each of the rod-shaped light guide structures is convex rod-shaped light guide structures, each of the rod-shaped light guide structures has a top surface and a bottom surface parallel and congruent to each other and at least one side surface connecting the top surface and the bottom surface, and the bottom surface of each of the rod-shaped light guide structures directly contacts the lower surface of the light guide plate.

In an embodiment of the invention, a shape of each top surface includes circle, ellipse or polygon.

In an embodiment of the invention, each of the rod-shaped light guide structures is a concave rod-shaped light guide structures, and each of the rod-shaped light guide structures is a cylindrical body, an elliptical columnar body or a polygonal columnar body.

In an embodiment of the invention, a maximum width of each of the rod-shaped light guide structures is greater than or equal to 201 μm but less than or equal to 150 μm.

In an embodiment of the invention, a rod height of each of the rod-shaped light guide structures is greater than or equal to 2 μm but less than or equal to 15 μm.

In an embodiment of the invention, the display device further includes a first optical adhesive layer and a second optical adhesive layer. The first optical adhesive layer is disposed on the upper surface of the light guide plate. The second optical adhesive layer is disposed between the lower surface of the light guide plate and the display panel.

In an embodiment of the invention, refractivity of the first optical adhesive layer and the second optical adhesive layer are ranged from 1.38 to 1.65.

In an embodiment of the invention, the display device further includes a protective layer disposed above the light guide plate.

In an embodiment of the invention, the display device further includes an absorbent layer disposed on the light guide plate. The light guide plate is divided into a first light guide block and a second light guide block. The display surface is disposed corresponding to the first light guide block, the second light guide block extends outside of the display surface, and the absorbent layer is located on the second light guide block.

In an embodiment of the invention, the light guide plate and the rod-shaped light guide structures are seamlessly connected.

In an embodiment of the invention, the light source is a plurality of light-emitting diodes, and a light-emitting area of the light source is less than or equal to an area of the light incident surface.

In an embodiment of the invention, the display panel is a reflective display panel.

In view of the above, because the display device of the invention has the rod-shaped light guide structures disposed on the light guide plate, when light incidents into the upper surface of the light guide plate via an optical action (e.g., reflection or refraction) of the rod-shaped light guide structures, the light is apt to be reflected back into the display panel due to an incident angle of the incident light being relatively large. As a result, when comparing to the conventional microstructures having curved forms, the design of the rod-shaped light guide structures of the invention may effectively enhance the display contrast performance of the display device.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic cross-sectional view illustrating a display device according to an embodiment of the invention.

FIG. 1B is a partial perspective view illustrating a light guide plate and a plurality of rod-shaped light guide structures of the display device shown in FIG. 1A.

FIG. 2A is a schematic cross-sectional view illustrating a display device according to another embodiment of the invention.

FIG. 2B is a partial perspective view illustrating a light guide plate and a plurality of rod-shaped light guide structures of the display device shown in FIG. 2A.

### DESCRIPTION OF THE EMBODIMENTS

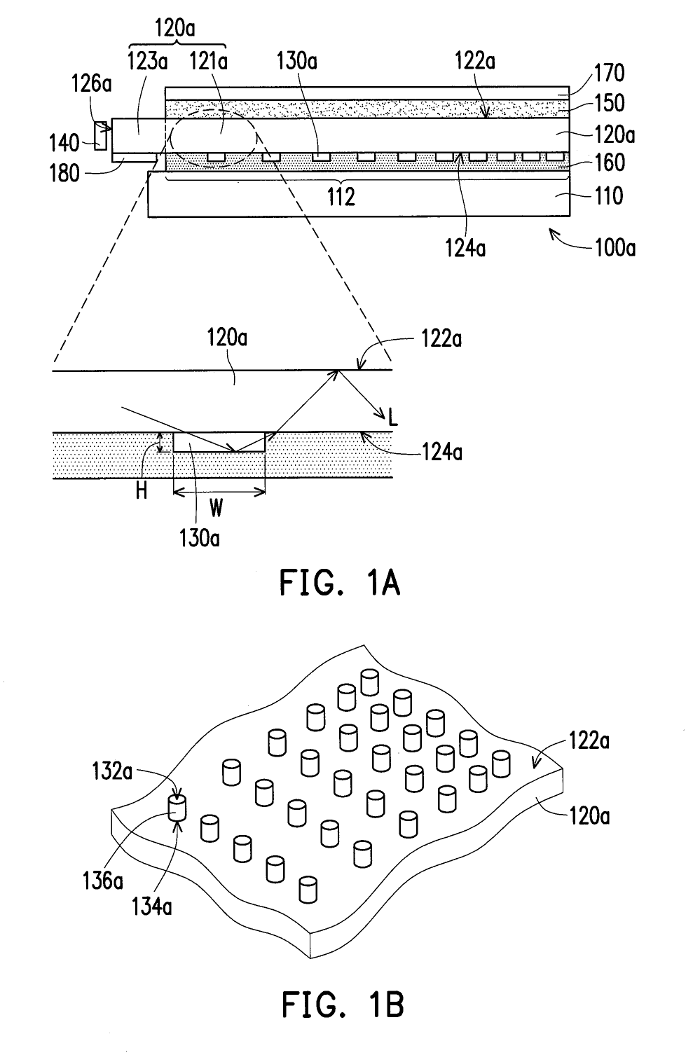

FIG. 1A is a schematic cross-sectional view illustrating a display device according to an embodiment of the invention. FIG. 1B is a partial perspective view illustrating a light guide plate and a plurality of rod-shaped light guide structures of the display device shown in FIG. 1A. Referring to FIG. 1A and FIG. 1B, the display device 100a of the present embodiment includes a display panel 110, a light guide plate 120a, a plurality of rod-shaped light guide structures 130a, and a light source 140. The display panel 110 has a display surface 112. The light guide plate 120a is disposed above the display surface 112 of the display panel 110 and has an upper surface 122a and a lower surface 124a opposite to each other and a light incident surface 126a connecting the upper surface 122a and the lower surface 124a. The rod-shaped light guide structures 130a is disposed on the lower surface 124a of the light guide plate 120a and exposes a portion of the lower surface 124a. Each of the rod-shaped light guide structures 130a protrudes the lower surface 124a of the light guide plate 120a. The light source 140 is disposed beside the light incident surface 126a of the light guide plate 120a.

In detail, the display panel 110 of the present embodiment is a reflective display panel, such as an electrophoretic display panel, but not limited thereto. The light guide plate 120a is disposed above the display surface 112 of the display panel 110, which is in front of the display panel 110, and thus the combination of the light guide plate 120a and the light source 140 may be considered as a front-light module. The light guide plate 120a may be divided into a first light guide block 121a and a second light guide block 123a. The display surface 112 of the display panel 110 is disposed corresponding to the first light guide block 121a, and the second light guide block 123a extends outside of the display surface 112. Herein, the light source 140 is, for example, composed of a plurality of dot light sources, such as a plurality of light-emitting diodes. Certainly, in other embodiments, the light source 140 may also be composed of cold cathode fluorescent lamp, but not limited thereto. In addition, a light-emitting area of the light source 140 may be smaller than or equal to an area of the light incident surface 126a of the light guide plate 120a, so as to ensure that the light emitted by the light source 140 may all be guided through the light guide plate 120a.

Furthermore, each of the rod-shaped light guide structures 130a of the present embodiment is substantially a convex rod-shaped light guide structure. In detail, each of the rod-shaped light guide structures 130a has a top surface 132a and a bottom surface 134a parallel and congruent to each other and at least one side surface 136a connecting the top surface 132a and the bottom surface 134a, and the bottom surface 134a of each of the rod-shaped light guide structures 130a directly contacts the lower surface 124a of the light guide plate 120a. It is worth mentioning that a completely flattened shape of the side surface 136a of each of the rod-shaped light guide structures 130a of the present embodiment is substantially a rectangle, and thus a cross-sectional shape of each of the rod-shaped light guide structures 130a is a convex rectangle, and the side surface 136a of each of the rod-shaped light guide structures 130a and the lower surface 124a of the light guide plate 120a are substantially appeared to be vertically connected, such that a radius of curvature thereof is 0.

Particularly, in the present embodiment, a distribution density of the rod-shaped light guide structures 130a increases as a distance thereof from the light incident surface 126a of the light guide plate 120a progressively increases. Namely, the farther away the rod-shaped light guide structures 130a are from the light incident surface 126a, the higher the distribution density; thereby effectively enhancing the light guiding effect of the light guide plate 120a. Herein, as shown in FIG. 1B, the top surface 132a of the rod-shaped light guide structures 130a is, for example, a circle, and thus the amount of the side surface 136a thereof is only one; however, in other not shown embodiments, the top surface of each of the rod-shaped light guide structures may also include an ellipse or a polygon, such as triangle, quadrangle, pentagon, or other regular polygon, but not limited thereto. Therefore, the amount of the side surface of each of the rod-shaped light guide structures can be changed due to the shapes of the top surface and the bottom surface.

Continue to referring to FIG. 1A, in the present embodiment, a rod height H each of the rod-shaped light guide structures 130a is, preferably, greater than or equal to 2 μm but less than or equal to 15 μm. A maximum width W of each of the rod-shaped light guide structures 130a is, preferably, greater than or equal to 20 μm but less than or equal to 150 μm. Because the rod-shaped light guide structures 130a of the present embodiment are designed with the special parameters as mentioned in above, light L entering the upper surface 122a of the light guide plate 120a may effectively have a larger incident angle. Furthermore, the light guide plate 120a and the rod-shaped light guide structures 130a of the present embodiment may be seamlessly connected (namely, integrally formed), or may be separate elements, but not limited thereto.

In addition, the display device 100a of the present embodiment includes a first optical adhesive layer 150 and a second optical adhesive layer 160. The first optical adhesive layer 150 is disposed on the upper surface 122a of the light guide plate 120a, and the second optical adhesive layer 160 is disposed between the lower surface 124a of the light guide plate 120a and the display panel 110. Preferably, refractivity of the first optical adhesive layer 150 and the second optical adhesive layer 160 are ranged between 1.38 and 1.65 and smaller than the refractivity of the light guide plate 120a. Furthermore, the display device 100a of the present embodiment may further include a protective layer 170, wherein the protective layer 170 may be disposed above the light guide plate 120a. As shown in FIG. 1A, the protective layer 170 may be fixed on the upper surface 122a of the light guide plate 120a via the first optical adhesive layer 150, and the display panel 110 may be fixed on the lower surface 124a of the light guide plate 120a via the second optical adhesive layer 160.

Moreover, in order to enhance a display quality of the display device 100a, the display device 100a of the present embodiment may also include an absorbent layer 180 disposed on the second light guide block 123a of the light guide plate 120a and located on the lower surface 124a. Herein, the absorbent layer 180 is, for example, a black tape layer or a white tape layer, which may effectively reflect or scatter the light that enters the light guide plate 120a from light source 140, so that the light entering the display panel 110 may be more even.

Referring to FIG. 1A again, because the lower surface 124a of the light guide plate 120a of the present embodiment is disposed with the rod-shaped light guide structures 130a, the light L is firstly reflected to the side surface 136a and then refracted to the lower surface 124a of the light guide plate 120a when being incident into the top surfaces 132a of the rod-shaped light guide structures 130a. Next, the light L is incident to the upper surface 122a of the light guide plate 120a. Since the incident angle of the light L that incidents into the upper surface 122a of the light guide plate 120a is relatively large, perhaps even larger than a threshold angle, the light L may be reflected or totally reflected into the display panel 110 again. As a result, the display device 100a of the present embodiment may have a favorable display contrast performance due to the design of the rod-shaped light guide structures 130a.

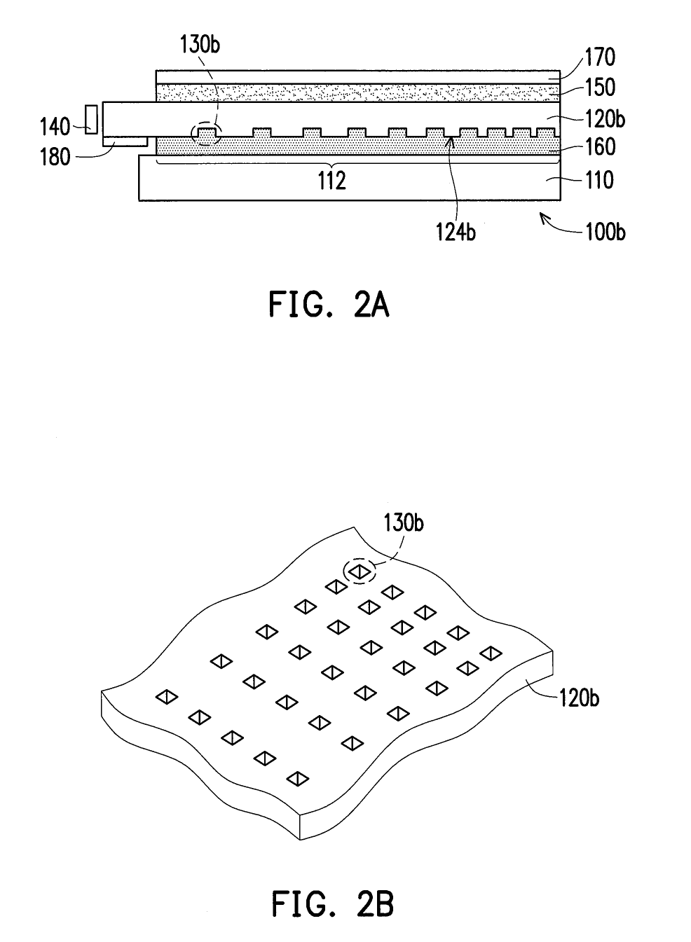

In describing the present embodiment, the reference numerals and part of the contents of the previous embodiment are used, where the same reference numerals refer to the same or similar elements, and descriptions of the same technical contents are omitted. In addition, the descriptions regarding the omitted part may be referred to the previous embodiments, and thus is not repeated herein. FIG. 2A is a schematic cross-sectional view illustrating a display device according to another embodiment of the invention. FIG. 2B is a partial perspective view illustrating a light guide plate and a plurality of rod-shaped light guide structures of the display device shown in FIG. 2A. Referring to FIG. 1A and FIG. 2A at the same time, the display device 100b of the present embodiment is similar to the display device 100a of the FIG. 1A, and a main difference therebetween lies in that: each of the rod-shaped light guide structures 130b of the present embodiment is substantially a concave rod-shaped light guide structure, namely, the rod-shaped light guide structures 130b are imbedded into the lower surface 124b of the light guide plate 120b. As shown in FIG. 2B, each of the rod-shaped light guide structures 130b of the present embodiment is substantially a polygonal columnar body, namely, a quadrangular columnar body; and, in other not shown embodiments, each of the rod-shaped light guide structures may also be a cylindrical body, an elliptical columnar body or other polygonal columnar bodies, but not limited thereto.

In summary, the display device of the invention has the rod-shaped light guide structures disposed on the light guide plate, and thus when the light incidents into the upper surface of the light guide plate via an optical action (e.g., reflection or refraction) of the rod-shaped light guide structures, the light is apt to be reflected back into the display panel due to the incident angle of the incident light being relatively large. As a result, when comparing to the conventional microstructures having curved forms, the design of the rod-shaped light guide structures of the invention may effectively enhance the display contrast performance of the display device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display device, comprising:
a display panel, having a display surface;
a light guide plate, disposed above the display surface of the display panel and having an upper surface and a lower surface opposite to each other and a light incident surface connecting the upper surface and the lower surface;
a plurality of rod-shaped light guide structures, disposed on the lower surface of the light guide plate and exposing a portion of the lower surface, wherein each of the rod-shaped light guide structures protrudes outside or is embedded into the lower surface; and
a light source, disposed beside the light incident surface of the light guide plate.

2. The display device as recited in claim 1, wherein a distribution density of the rod-shaped light guide structures increases as a distance thereof from the light incident surface progressively increases.

3. The display device as recited in claim 1, wherein each of the rod-shaped light guide structures is convex rod-shaped light guide structures, each of the rod-shaped light guide structures has a top surface and a bottom surface parallel and congruent to each other and at least one side surface connecting the top surface and the bottom surface, and the bottom surface of each of the rod-shaped light guide structures directly contacts the lower surface of the light guide plate.

4. The display device as recited in claim 3, wherein a shape of each top surface comprises circle, ellipse or polygon.

5. The display device as recited in claim 1, wherein each of the rod-shaped light guide structures is a concave rod-shaped light guide structures, and each of the rod-shaped light guide structures is a cylindrical body, an elliptical columnar body or a polygonal columnar body.

6. The display device as recited in claim 1, wherein a maximum width of each of the rod-shaped light guide structures is greater than or equal to 20 μm but less than or equal to 150 μm.

7. The display device as recited in claim 1, wherein a rod height of each of the rod-shaped light guide structures is greater than or equal to 2 μm but less than or equal to 15 μm.

8. The display device as recited in claim 1, further comprising:
a first optical adhesive layer, disposed on the upper surface of the light guide plate;
a second optical adhesive layer, disposed between the lower surface of the light guide plate and the display panel.

9. The display device as recited in claim 8, wherein refractivity of the first optical adhesive layer and the second optical adhesive layer are ranged from 1.38 to 1.65.

10. The display device as recited in claim 1, further comprising:
a protective layer, disposed above the light guide plate.

11. The display device as recited in claim 1, further comprising:
an absorbent layer, disposed on the light guide plate, wherein the light guide plate is divided into a first light guide block and a second light guide block, the display surface is disposed corresponding to the first light guide block, the second light guide block extends outside of the display surface, and the absorbent layer is located on the second light guide block.

12. The display device as recited in claim 1, wherein the light guide plate and the rod-shaped light guide structures are seamlessly connected.

13. The display device as recited in claim 1, wherein the light source is a plurality of light-emitting diodes, and a light-emitting area of the light source is less than or equal to an area of the light incident surface.

14. The display device as recited in claim 1, wherein the display panel is a reflective display panel.
